(19) United States
(12) Patent Application Publication
(10) Pub. No.: US 2006/0004837 A1
(43) Pub. Date: Jan. 5, 2006

(54) Advanced switching peer-to-peer protocol

(76) Inventors: Victoria V. Genovker, Phoenix, AZ (US); Ward McQueen, Chandler, AZ (US); Mohamad Rooholamini, Gilbert, AZ (US); Bo Z. Li, San Diego, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/882,902

(22) Filed: Jun. 30, 2004

(51) Int. Cl. G06F 17/00

(52) U.S. Cl. 707/102

(57) ABSTRACT

A peer-to-peer connection protocol for establishing and managing peer-to-peer connections between endpoints coupled via a serial-based interconnect fabric. A requesting endpoint generates and sends a query to a fabric manager requesting connection information for at least one target endpoint having attributes matching attributes specified in the query. The fabric manager returns a query reply containing connection information to connect the requesting endpoint to a target endpoint or multiple target endpoints having matching attributes. In the case of multiple target endpoints, one target endpoint is selected for the connection. The requesting and target endpoints then negotiate and establish the connection by passing connection information and parameters between themselves directly. Upon establishing the connection, the fabric manager is apprised of the new connection and updates its connection list. The method is facilitated by software components running on various devices coupled to the serial-based interconnect fabric. Such devices include server blades and ATCA boards. In one embodiment, the serial-based interconnect fabric comprises an Advanced Switching (AS) fabric.

### FIELD OF THE INVENTION

The field of invention relates generally to computer and processor-based systems, and, more specifically but not exclusively relates to techniques for managing peer-to-peer communication links facilitated by serial-based interconnect fabrics.

### BACKGROUND INFORMATION

The communications industry is undergoing two significant trends: greater convergence with computing technologies and a changing value chain that is catalyzing development and adoption of modular platforms for deploying complex, converged solutions. Added to these trends is the realization that the silicon industry, at an interconnect level, is no longer segmented by computer and communications, as it historically has been. Moreover, the current view of the silicon industry more closely resembles one body of component manufacturers who look to leverage the collective industry investments in order to reduce costs and embrace market trends. Combined, these impact the choices of interconnect technologies within next-generation communication systems.

Over their histories, computing has evolved around a single board-level interconnect (for example, the current de facto interconnect is the Peripheral Component Interconnect (PCI)), while communications equipment has historically incorporated many board-level and system-level interconnects, some proprietary, while others being based on standards such as PCI. As the two disciplines converge, an abundance of interconnect technologies creates complexity in interoperability, coding, and physical design, all of which drive up cost. The use of fewer, common interconnects will simplify the convergence process and benefit infrastructure equipment developers.

In addition, today's telecommunication industry dilemma of growing network traffic, flat revenue, and reduced capital and operating spending has resulted in developing a modular approach to building communications solutions. Modularity allows complex systems to be integrated from system-level and board-level building blocks connected through common interconnects. The modularity model is attractive to many suppliers because of the cost and time-to-market for building complex systems. For example, the Advanced Telecom Computer Architecture (AdvancedTCA or ATCA) (PICMG 3x) specifies a modular platform for both computing and communications elements to reside in a single chassis.

Industry-standard interconnects that can be reused among multiple platforms are key to both convergence and a modular system design approach. Common chip-to-chip interconnects enable greater designs reuse across boards and improve interoperability between the computing and communication functions. A common system fabric enables board-level modularity by standardizing the switching interfaces between various line cards in a modular system. Fewer, common interconnects also reduce complexity in software and hardware, and simplify system design. Additionally, simplification and reuse drive down costs and development time in modular components.

As originally specified, the PCI standard (e.g., PCI 1.0) defined an interconnect structure that simultaneously addressed the issues of expansion, standardization, and management. The original scheme employed a hierarchy of busses, with “bridges” used to perform interface operations between bus hierarchies. The original PCI standard was augmented by the PCI-X standard, which was targeted towards PCI implementations using higher bus speeds.

The convergence trends of the compute and communications industries, along with reorganization of the inherent limitations of bus-based interconnect structures, has lead to the recent immergence of serial interconnect technologies. Serial interconnects reduce pin count, simplify board layout, and offer speed, scalability, reliability and flexibility not possible with parallel busses, such as employed by PCI and PCI-X. Current versions of these interconnect technologies rely on high-speed serial (HSS) technologies that have advanced as silicon speeds have increased. These new technologies range from proprietary interconnects for core network routers and switches to standardized serial technologies, applicable to computing, embedded applications and communications.

One such standardized serial technology is the PCI Express architecture. The PCI Express architecture is targeted as the next-generation chip-to-chip interconnect for computing. The PCI Express architecture was developed by a consortium of companies, and is managed by the PCI SIG (special interest group). In addition to providing a serial-based interconnect, the PCI Express architecture supports functionalities defined in the earlier PCI and PCI-X bus-based architectures. As a results, PCI and PCI-X compatible drivers and software are likewise compatible with PCI Express devices. Thus, the enormous investment in PCI software over the last decade will not be lost when transitioning to the new PCI Express architecture.

While the “PCI inheritance” aspect of PCI Express is a significant benefit, it also results in some limitations due to the continued support of “legacy” devices employing personal computer (PC) architectural concepts developed in the early 1980's. To overcome this, as well as other limitations, a new technology called Advanced Switching (AS) has been recently introduced. AS enhances the capabilities of PCI Express by defining compatible extensions, including extensions that address the deficiencies in legacy monolithic processing architectures. AS further includes inherent features targeted toward the communications markets, including data-plane functions, flexible protocol encapsulation, and more.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is block diagram of a layered architecture illustrated primary layers in the PCI Express and the Advanced Switching (AS) standards;

FIG. 2 is a schematic block diagram showing an exemplary AS use model corresponding to a communications implementation;

FIG. 3 is a block schematic diagram illustrating software components in a distributed software architecture, according to one embodiment of the invention;

FIG. 4 is a block schematic diagram illustrating details of software sub-components and interfaces corresponding to the Primary Fabric Management (PFM) component of FIG. 3;

FIG. 5 is a block schematic diagram illustrating details of software sub-components and interfaces corresponding to the Endpoint (EP) component of FIG. 3;

FIG. 6 is a block schematic diagram illustrating details of software sub-components and interfaces corresponding to the Secondary Fabric Management (SFM) component of FIG. 3;

FIG. 7 is a block schematic diagram illustrating details of software sub-components and interfaces corresponding to the AS driver component of FIG. 3;

FIG. 8 is a schematic diagram illustrating an exemplary implementation architecture that includes a PFM system, SFM system and two EP systems, each running on a respective platform comprising an AS device coupled to an AS Fabric;

FIG. 9 is a flowchart illustrating operations performed to establish a peer-to-peer connection between a requesting endpoint and a target endpoint, according to one embodiment of the invention;

FIG. 10 is a message flow diagram illustrating details of messages passed between a requesting endpoint, fabric manager, and target endpoint in accordance with the peer-to-peer connection establishment process of FIG. 9;

FIG. 11 is a schematic diagram illustrating a scheme for storing attribute information from which characteristics and capabilities of a PCI Express device can be specified;

FIG. 12 is a flowchart illustrating operations performed to close a peer-to-peer connection; according to one embodiment of the invention;

FIG. 13a is a frontal isometric view of an exemplary blade server chassis in which a plurality of server blades are installed;

FIG. 13b is a rear isometric view of the blade server chassis of FIG. 13a;

FIG. 14a is a frontal isometric view of an exemplary ATCA chassis;

FIG. 14b is an isometric view of an exemplary ATCA board; and

FIG. 15 is a schematic diagram of an exemplary AS communications ecosystem.

### DETAILED DESCRIPTION

Embodiments of methods and apparatus for managing peer-to-peer communication in serial-based interconnect fabric environments, such as an Advanced Switching (AS) environment, are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

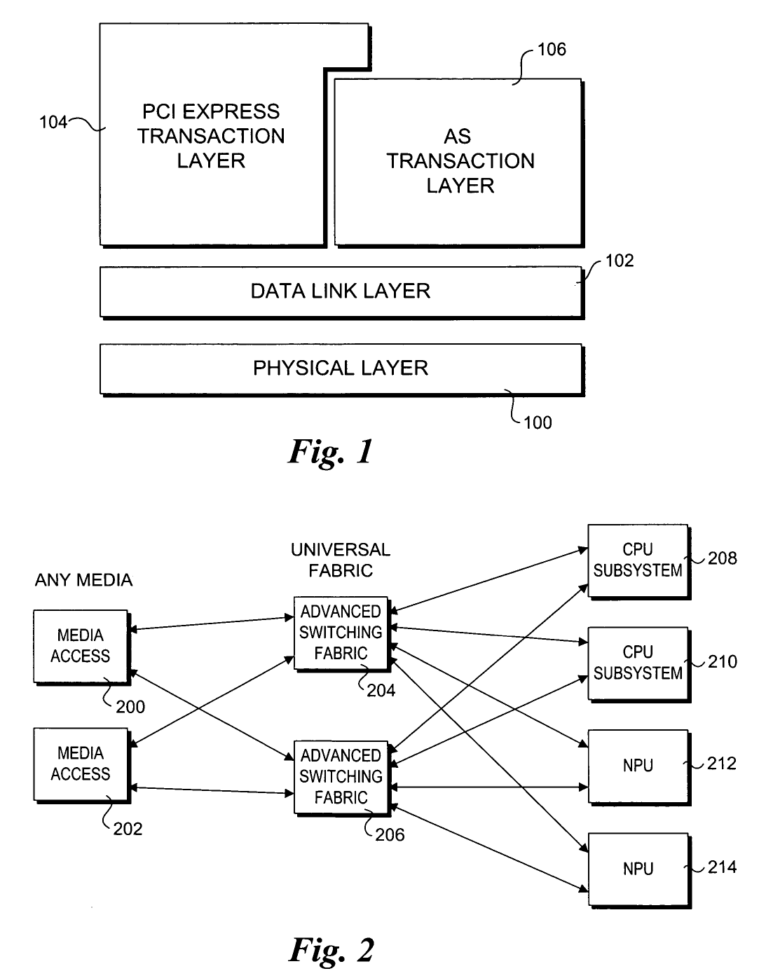

As shown in FIG. 1, both PCI Express and AS are multi-layered protocols. Each technology consists of a physical layer 100, a data link layer 102, and a transaction layer of which the physical and data link layers are common. The transactions layers include a PCI Express transaction layer 104 and an AS transaction layer 106.

A fundamental goal of PCI Express is to provide an easy migration strategy to expand from the legacy PCI technology into the new serial-based link technology. PCI Express accomplishes this by being fully compatible to the existing PCI hardware and software architectures. As a result, PCI Express also inherits the limitations of a global memory address-based and tree topology architecture. This limits the ability of PCI Express to be effectively utilized in peer-to-peer communications between multiple hosts in various topologies, such as star, dual-star, and meshes. These topologies are typically used in blade servers, clusters, storage arrays, and telecom routers and switches.

The PCI Express architecture is based upon a single host processor or root complex that controls the global memory address space of the entire system. Upon power-up and enumeration process, the root complex interrogates the entire system by traversing through the hierarchical tree-topology and locates all endpoint devices that are connection in the system. A space is allocated for each endpoint device in the global memory in order for the host processor to communicate with it.

To facilitate improved peer-to-peer communication, PCI Express extends the inherent transparent bridging concept of PCI to non-transparent bridges. This technique is typically used in applications where there are one or more sub-processing system or intelligent endpoints that require their own isolated memory space. In a non-transparent bridge, both sides of the bridge are logically treated as endpoints from each local processor's perspective. A mirror memory space of equal size is independently allocated on each side of the bridge during each processor's enumeration process. The non-transparent bridge is programmed to provide the address translation function in each direction between the two processor memory maps.

Neither PCI Express nor the use of non-transparent bridges provides adequate congestion management required for highly utilized peer-to-peer communications. In peer-to-peer environments where many highly utilized host processors are pushing and pulling data independently and simultaneously, there needs to be a more sophisticated level of congestion management to control the behavior and communications between the interconnected processors. Non-transparent bridges also require an extensive amount of software provisions and reconfiguration to implement fail-over mechanisms in high availability systems. This results in additional design complexity, resource utilization and response times that may not be tolerable for certain applications.

In view of the foregoing shortcomings, the Advanced Switching architecture was designed to provide a native interconnect solution for multi-host, peer-to-peer communications without additional bridges or media access control. AS employs a packet-based transaction layer protocol that operates over the PCI Express physical and data link layers (e.g., physical layer 100 and data link layer 102 in FIG. 1). Advanced Switching provides enhanced features such as sophisticated packet routing, congestion management, multicast traffic support, as well as fabric redundancy and fail-over mechanism to support high performance, highly utilized, and high availability system environments.

An exemplary Advanced Switching use model is shown in FIG. 2. This particular use model is targeted toward telecommunications usage; however, AS may be applicable to many types of communications and computer environments. The use model includes media access elements 200 and 202, each cross-connected to AS fabric elements 204 and 206. Each of the AS fabric elements 204 and 206 are, in turn, cross-connected to CPU (central processing unit) sub-systems 208 and 210, as well as network processor units (NPUs) 212 and 214.

As discussed above, AS is media and switching fabric agnostic, meaning the AS protocol functions the same regardless of the underlying media and switching fabric implementation. Furthermore, AS can support underlying communication protocols, via protocol encapsulation. For example, AS includes internal protocol interfaces that can be used to tunnel various protocols such as Ethernet, Fibre Channel, and Infiniband.

To fully exploit the features of AS, software is required to configure and manage a fabric consisting of AS components. In accordance with one embodiment of the invention, an AS software architecture is disclosed herein that is implemented via a distributed set of components. Each component is specialized to perform a task or set of related tasks. This modular scheme allows components of software to be invoked only if certain functionality is required.

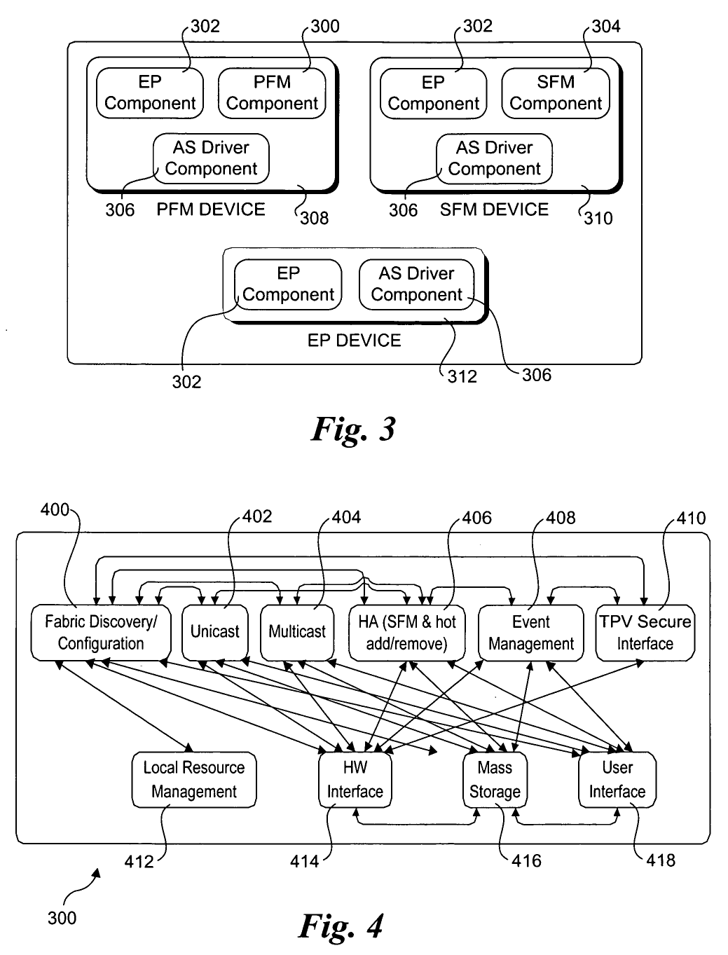

As shown in FIG. 3, in one embodiment, the architecture includes four major components. This include a Primary Fabric Manager (PFM) component 300, an endpoint (EP) component 302, a Secondary Fabric Manager (PFM) component 304, and an AS driver component 306.

Depending on the particular physical infrastructure, various members of the foregoing components will be executed on various system devices. The exemplary configuration shown in FIG. 3 includes three types of such devices: a PFM device 308, an SFM device 310, and an EP device 312. As described below in further details, under some configurations a single device may serve as both a PFM or SFM device and an EP device.

Details of sub-components and interfaces therebetween of PFM component 300, according to one embodiment, are shown in FIG. 4. The sub-components include a fabric discovery/configuration sub-component 400, a unicast sub-component 402, a multicast sub-component 404, a High Availability (HA) sub-component 406, a event management sub-component 408, a third-party vendor (TPV) secure interface 410, a local resource management sub-component 412, a hardware (HW) interface 414, a mass storage interface 416, and user interface 418.

The fabric discovery/configuration sub-component 400 is responsible for discovery and configuration of the fabric by the initial PFM or by a new PFM when the existing PFM fails. Additionally, as devices are hot added/removed from a system, this sub-component performs re-discovery of the fabric, if needed, and configures the new devices.

The unicast sub-component 402 implements the unicast protocol defined by the software design. It is responsible for the tasks that are related to and management of point-to-point (PtP) communications between EPs in the fabric.

The multicast sub-component 404 implements the multicast protocol defined by the software design. It is responsible for the tasks that are related to and management of multicast communications between EPs in the fabric.

The High Availability sub-component 406 implements the HA protocol defined by the software design. It is responsible for establishing a secondary fabric manager in the fabric and synchronizing the fabric data and tasks related to devices/links failure and/or hot added/removed devices.

The event management sub-component 408 manages events that are received from the fabric. Generally, the events may be informational or they may indicate error conditions.

The TPV secure interface 410 provides an interface between third party vendor software through an AS driver component 306. This interface provides access to the vendor's specific devices and their proprietary registers in the fabric. However, to provide security and to allow only authorized software to access devices, the TPV sub-component in the AS driver component interfaces to the TPV interface in the PFM and to the TPV software in order to route packets between the two. Only valid requests are granted access to the fabric by the PFM.

The local resource management sub-component 412 provides an interface to the local resources (such as memory) that exist on the PFM host device.

The HW interface 414 provides an interface to the AS driver component 306. It is through this interface that packets are sent/received to/from the fabric.

The mass storage interface 416 sub-component provides an interface to a mass storage device (such as disk drive) that may exist on the device.

The user interface 418 sub-component provides a user interface to display fabric-related information such as fabric topology and current PtP connections. Additionally, connections can be initiated between EPs in the fabric through this interface.

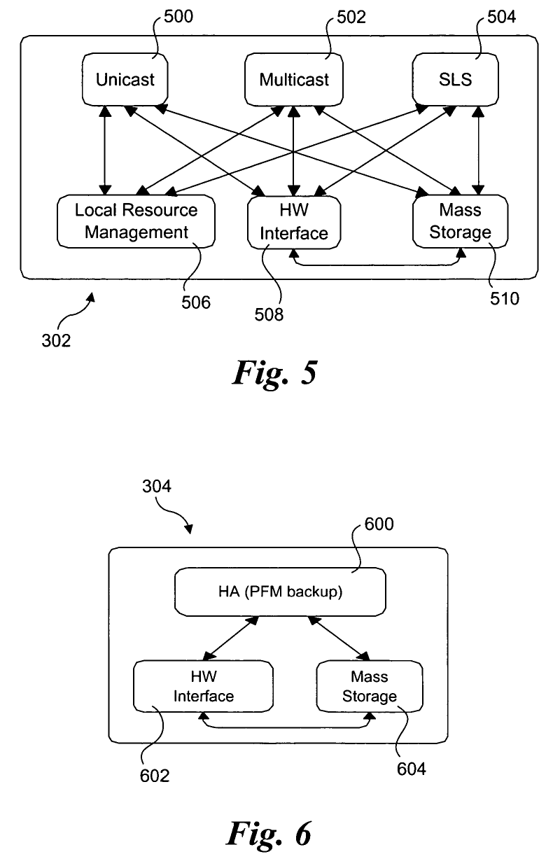

The EP component 302 is made up of tasks that are performed by an EP device. FIG. 5 shows one embodiment of the sub-components making up the EP component and the interfaces between them. The sub-components include a unicast sub-component 500, a multicast sub-component 502, a simple load/store (SLS) sub-component 504, a local resource management sub-component 506, a hardware interface sub-component 508, and a mass-storage interface sub-component 510.

The unicast sub-component 500 implements the unicast protocol defined by the software design. It is responsible for the tasks that are related to establishing and management of PtP communications between this device and other EPs in the fabric. This is the EP matching component of the PFM's unicast sub-component 402.

The multicast sub-component 502 implements the multicast protocol defined by the software design. It is responsible for the tasks that are related to establishing and management of multicast communications between the host device for the multicast sub-component and other EPs in the fabric. This is the EP matching component of the PFM's multicast sub-component 404.

The simple load/store (SLS) sub-component 504 is responsible for the management of all the SLS connections between its host device and other EPs in the fabric. It creates SLS connections and instructs its SLS counterpart in the AS driver to configure and store the connection for SLS applications.

The local resource management sub-component 506 provides an interface to the local resources (such as memory) that exist on the device hosting an EP component 302.

The HW interface 508 provides an interface to an instance of AS driver component 306. It is through this interface that packets are sent/received to/from the fabric.

The mass storage interface 510 sub-component provides an interface to a mass storage device (such as a disk drive) that exists on the EP component host device.

The SFM component 304 is made up of tasks performed by the secondary fabric manager. FIG. 6 shows the sub-components making up the SFM component and the interfaces between them. These include a High Availability (HA) sub-component 600, a hardware interface 602, and a mass storage interface 604.

The High Availability sub-component 600 implements the HA protocol defined by the software design. It is responsible for establishing a connection with the PFM in the fabric, synchronizing the fabric data with it, and monitoring the PFM. Additionally, it is responsible for failing-over to the PFM component if it determines that it has failed. This is the matching component of the PFM's HA sub-component 300.

The HW interface 602 provides an interface to an instance of AS driver component 306. It is through this interface that packets are sent/received to/from the fabric.

The mass storage interface 604 sub-component provides an interface to the mass storage (such as hard disk) that exists on the EP component host device.

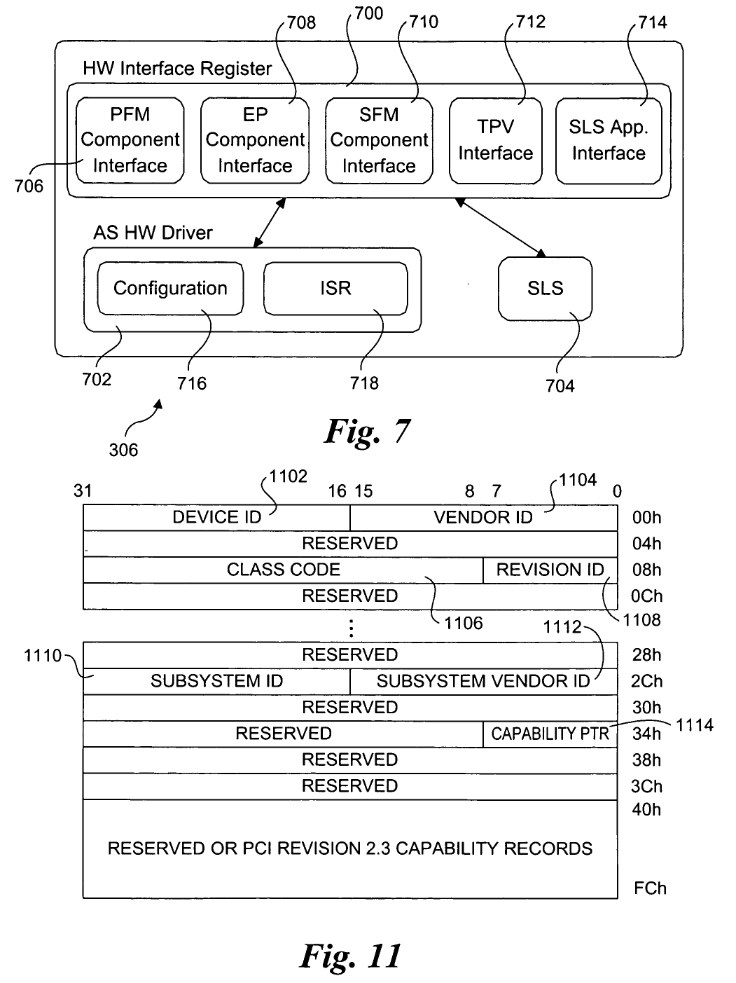

The AS Driver component 306 is made up of the tasks to initialize the hardware to send/receive packets to/from the fabric and it provides interfaces to the other components. FIG. 7 shows the sub-components making up this component and the interface between them.

The sub-components include a hardware interface register 700, an AS hardware driver 702, and an SLS sub-component 704. The hardware interface register includes a PFM component interface 706, and EP component interface 708, an SFM component interface 710, a TPV interface 712, and an SLS application interface 714. The AS hardware driver 702 includes a configuration sub-component 716 and interrupt service routines 718.

The hardware interface register 700 provides an interface to user-level application programs. Through these interfaces the applications discussed above are enabled to send/receive packets to/from the fabric. Each application registers with this sub-component for the packet types that it sends/receives.

The TPV interface 712 sub-component provides interfaces to the third party vendor software and to its TPV counterpart in PFM component 300. Requests coming to the driver from third party software to access certain devices in the fabric will be verified with the PFM to determine if the request is to be granted or not. This sub-component provides interfaces to route packets between the TPV software and the PFM. The PFM then provides the security to whether allow a packet to the fabric or not by TPV software and which TPV software, if any, is the recipient of a packet from the fabric.

The AS hardware driver 702 sub-component is responsible for the initial configuration of the hardware devices. Additionally, it provides the interrupt service routines 718 for the devices.

The SLS sub-component 704 is a counterpart of SLS sub-component 504 in EP component 302. It is instructed from the EP component to configure SLS connections while SLS sub-component 504 in the EP creates the connections. Additionally, it saves connection information so that the applications requesting SLS connection can directly interface with it in order to send/receive SLS packets.

In general, the various software components discussed herein may be implemented using one or more conventional architecture structures. For example, a component or sub-component may comprise an application running on an operating system (OS), an embedded application running with or without an operation system, a component in an operating system kernel, an operating system driver, a firmware-based component, etc.

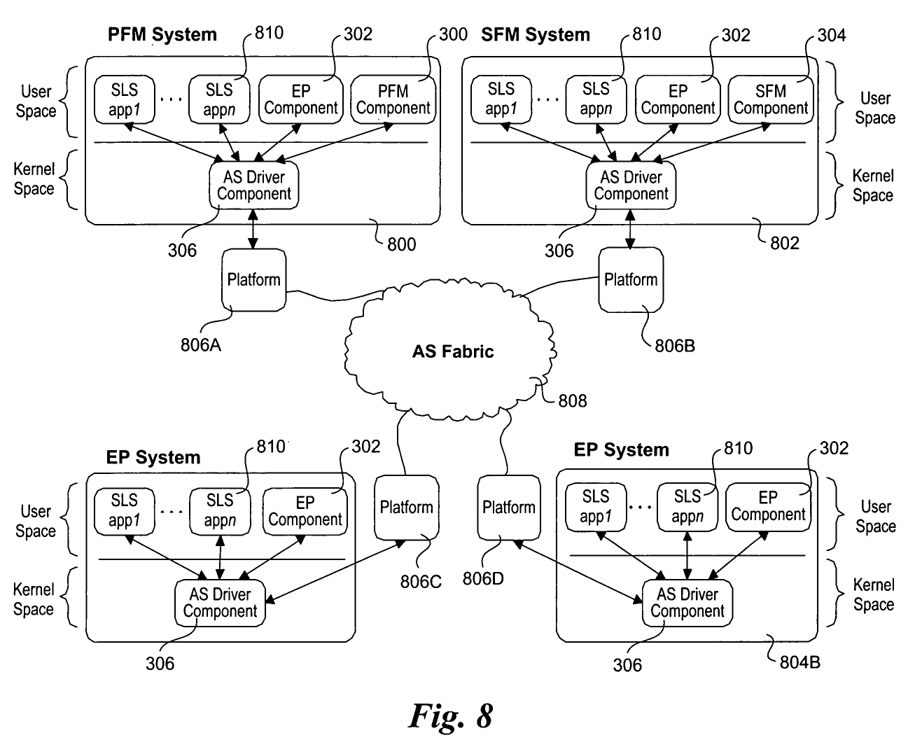

FIG. 8 shows an exemplary software architecture in which some of the various software components are embodied as applications running in the user space of an operating system, while other components are embodied as OS kernel space components. The software components are used to host a PFM system 800, an SFM system 802, and EP systems 804A and 804B. In the illustrated embodiment, each software system is run by one or more processors provided by a respective platform 806A, 806B, 806C, and 806D. The term “platform” is used herein to refer to any type of computing device suitable for running a PFM, SFM or EP system. Thus, platforms include, but are not limited to, server blades, telecom line cards, and ATCA boards.

While the various software systems are shown running on respective platforms, it will be understood that this is merely exemplary. In other configuration, multiple software systems may be hosted by the same platform. For example, a single platform may operate as both a PFM system and an EP system. Similarly, a single platform may operate as both an SFM system and an EP system. For reliability reasons, PFM systems and SFM systems will typically be hosted by separate platforms.

Each of platforms 806A-D is linked in communication with the other platforms via an AS fabric 808. The AS fabric facilitates serial interconnects between devices coupled to the physical AS fabric components. In general, the AS fabric components may include dedicated AS switching devices, an active backplane with build-in AS switching functionality, or the combination of the two.

The PFM system 800 comprises a set of software components used to facilitate primary fabric management operations. These components include one or more SLS applications 810, an EP component 302, a PFM component 300, and an AS driver component 306. The SLS application, EP component, and PFM component comprise applications running in the user space of an operating system hosted by platform 806A. Meanwhile, the AS driver component comprises an OS driver located in the kernel space of the OS.

The software components of SFM system 802 are configured in a similar manner to those in PFM system 800. The user space components include one or more SLS applications 810, an EP component 302, and an SFM component 304. An AS driver component is located in the kernel space of the operating system hosted by platform 806B.

Each of EP systems 804A and 804B are depicted with similar configurations. In each EP system, the user space components include one or more SLS applications 810 and an EP component 302. As with the PFM and SFM systems, an AS driver component 306 is located in the kernel space of the operating system running on the platform hosting an EP system (e.g., platforms 806C and 806D.

In general, AS fabric management can be performed using one of three models, each with their own advantages and disadvantages. Under a centralized fabric management model, there is a central FM authority in the fabric that runs the AS fabric. The FM has full view of the fabric, is aware of all the activities in the fabric, and is responsible for all the fabric-related tasks. Under a decentralized fabric management model, there is no central FM authority, and the fabric-related information is not maintained in a central location. EPs perform their own discovery, establish their own connections and perform other tasks without intervention by the FM. This model supports multiple FMs. Under a hybrid fabric management model, there are certain fabric related tasks that are done in a centralized fashion, while other tasks are done in a decentralized fashion. For example, the FM performs tasks such as device discovery, while the EPs do other tasks on their own, such as establishing their own connections.

In one embodiment, the hybrid fabric management model is used to manage unicast peer-to-peer connections. Under this approach, the fabric topology and the information about devices are collected and maintained by the FM. Devices query the FM for matches (centralized), but they negotiate and establish their own PtP connections without the FM's involvement using the data provided by the FM (decentralized). This design allows for a powerful fabric-wide control, for example in support of HA features such as path fail-over, while leaving the task of establishing connections up to the peers, and hence distributing the work.

A primary function performed by an FM is Fabric Discovery (FD). FD is one of the key software components of the fabric management suite. During FD, the FM records which devices are connected, collects information about each device in the fabric, constructs a map of the fabric, and configures appropriate capabilities and/or tables in the devices configuration space. There are several approaches to how the FM might collect the information about all the devices. In one embodiment, a fully distributed mechanism is employed, wherein the FM may concurrently collect information from more than one device.

In one implementation, discovery happens in three stages—enumeration, reading devices' configuration space (capabilities and tables), and configuring devices (writing into capabilities and tables). During the enumeration phase, the FM performs three tasks, including visiting each device through all paths leading to that device, collecting certain capabilities' offsets for each device discovered, and initializing each device's serial number if a serial number is not already initialized (by the manufacturer, firmware, etc.).

After power-on, a full discovery and configuration algorithm is run by the Primary Fabric Manager. Additionally, the Primary and Secondary Fabric Managers may perform discovery and configuration operations during fabric run-time, such as in response to the detection of a hot install/remove event. In the event of a failure, FM operations that were previously performed by a PFM are performed by an SFM, which reconfigures itself as the new PFM for the system.

One of the most valuable functions facilitated by AS is peer-to-peer communication, also known as unicast communication or a unicast link. In one embodiment, a unicast protocol facilitated by an FM component and an EP component are employed to manage unicast operations. The FM component (e.g., PFM unicast sub-component 402) runs on the PFM device, while the EP component (e.g., EP unicast sub-component 500) runs on each EP device.

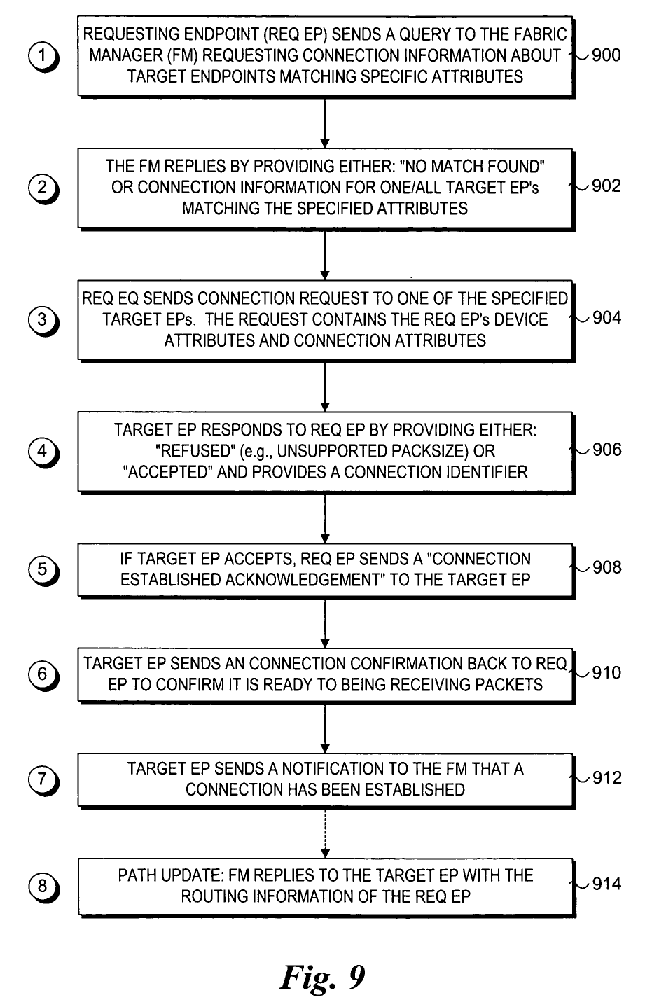

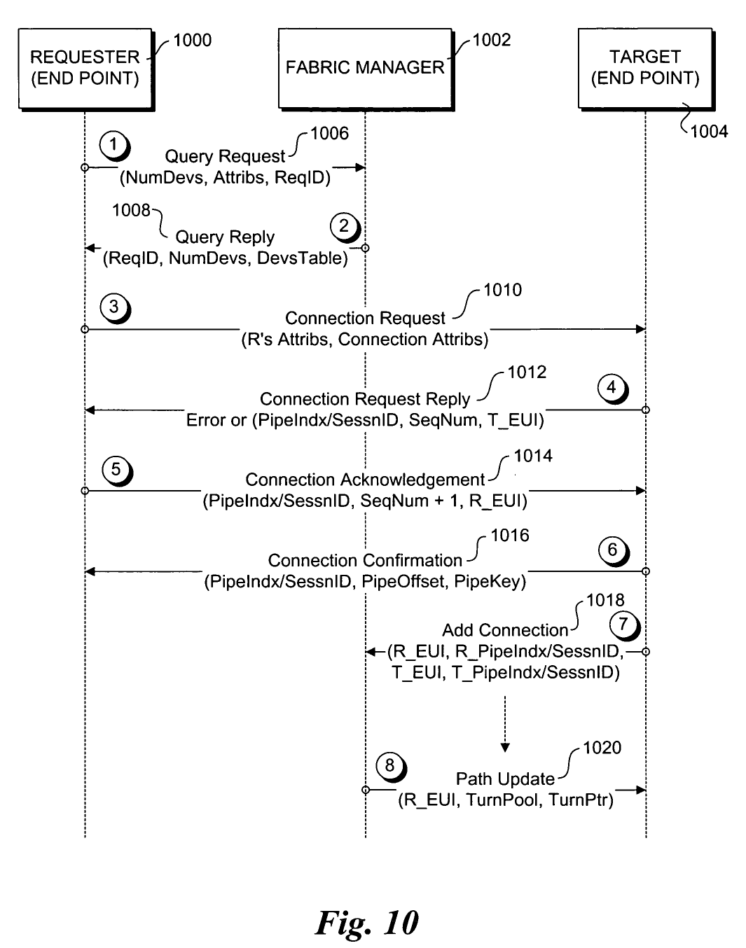

To perform a peer-to-peer communication between EP devices, a unicast link must first be established. Operations for setting up an unicast link, according to one embodiment, are shown in FIG. 9, while FIG. 10 illustrates a set of messages corresponding to the flowchart of FIG. 9 that are passed between a requester EP 100, a fabric manager 1002, and a target EP 1004 to perform the unicast link setup task.

The setup process begins in a block 900, wherein a requesting endpoint sends a query to the fabric manager requesting connection information about target endpoints matching specific attributes identified in the request. This message is depicted as a Query Request 1006 in FIG. 10, which is sent from request EP 1000 to fabric manager 1002. In the context of the implementation configuration of FIG. 8, this message might originate from one of platforms 806C and 806D, and would be passed from the originating endpoint host platform to the platform hosting the fabric manager (e.g., platform 806A). In one embodiment, Query Request 1006 includes a NumDevs parameter, an attributes parameter set, and a request identifier (ReqID).

During the aforementioned discovery and configuration operations, the fabric manager collects information about each device installed in a system managed by the FM. This is facilitated by well-known techniques provided by the PCI (and PCI Express) architecture. Each PCI Express device stores information about its various device attributes, including capabilities and/or services supported by the device. The attribute information identifies functionality that may be accessed by the PCI Express device, such as mass storage or communication capabilities (via corresponding protocol interfaces), for example. The attributes parameter set (e.g., one or more attribute parameters in a list) is used, in part, to specify what capabilities a requesting EP would like to access.

In one embodiment, the attribute information is stored in a table structure 1100, as shown in FIG. 11. The table structure 1100 corresponds to the lower 256 bits of an AS device's configuration space. It includes a device ID 1102, a vendor ID 1104, a class code 1106, a revision ID 1108, a subsystem ID 1110, a subsystem vendor ID 1112, a capability pointer 1114, and various reserved fields.

The device ID 1102 comprises a 16-bit value assigned by the manufacturer of the device. The vendor ID 1104 is a 16-bit value assigned by PCI-SIG for each vendor that manufacturers PCI Express-compliant devices. The class code 1106 is a 24-bit value that indicates the class of the device, as defined by PCI-SIG. The subsystem ID 1110 and subsystem vendor ID 1112 are analogous to the device ID 1102 and vendor ID 1104, except they are applicable for devices that include PCI-compliant subsystems.

The capability pointer 1114 is an 8-bit field designated by the device vendor to indicate the location of the first PCI 2.3 capability record. For AS devices, this field contains a value between 40h and OF8h. One of the capability records identifies that the device as an AS device. In general, the capability records are used to provide information identifying services or capabilities provided by a device. The detailed capability information is stored in a separate configuration space (not shown).

The NumDevs parameter indicates the number of devices the FM should return connection information for if one or more devices are determined to match the requested attributes. If the value is set to 1, connection information corresponding to the first match found will be returned. If the value is set to 0, connection information for each device found will be returned.

Every time an endpoint sends out a request to the FM, it associates an ID with that request, as defined by the ReqID parameter. The FM returns that same ReqID when it replies to the request. When a reply comes back from the FM, the ID in the reply is matched to an ID in a requests table maintained by the EP.

Upon receiving a query request, the FM searches its configuration information to determine if any devices coupled to the fabric have attributes matching those contained in the request. In one embodiment, the FM maintains a table for each request. When a device having matching attributes is identified, a MatchInfo entry is added to the table. The MatchInfo entry contains connection information for a corresponding target EP, including a “turnpool” and a “turnpointer” (turnptr) value.

AS provides a source-based routing mechanism called “turn pools” to enable flexible data routing in a variety of system topologies. Turn pools contain routing information that is relative to the system topology and provided by the source. Therefore, as a packet travels through multiple switches in a system, the destination of the packet does not have to be resolved through destination-based lookups at each hop. This reduces complexity and minimizes latencies during data transfers.

In response to the Query Request 1006, the Fabric Manager replies in a block 902 via a Query Reply 1008, which indicates that either no match was found, or includes connection information for one or all target EP's matching the specified attributes (depending on the NumDevs parameter in Query Request 1006). The number of matching targets is identified by the NumDevs parameter in Query Reply 1008. The connection information for the one or more target EPs for which a match exists is contained in the DevsTable parameter.

Upon receiving Query Reply 1008, the requesting EP extracts the connection information, and selects a target EP in situations in which connection information for more than one target EP is returned in the query reply. If no match found is returned, there are no targets that meet the requesting EP's requirements and the connection process aborts. In a block 904, the requesting EP then sends a Connection Request 1010 directly to the target EP. The Connection Request includes the requester's attributes, along with connection attributes.

Upon receipt of Connection Request 1010, the target EP extracts the attribute and connection data from the request. The target then determines if it can and/or is willing to accept the connection or not. For example, if the request specifies an unsupported packet size, a connection should be refused. Connection may also be refused for other reasons, such as for traffic policy considerations. If the connection is refused, the target EP returns a Connection Request Reply 1012 including information indicating an error has occurred. If the connection is accepted, the Connection Request Replay 1012 includes a connection identifier. These operations are shown in a block 906 of FIG. 9.

In one embodiment, Connection Request Reply 1012 includes a pipe index or session ID, a sequence number, and the target EP's identifier. If the requester is going to be a writer (e.g., transmit data to be processed by the target EP), a pipe index is included in Connection Request Reply 1012. The pipe index serves as a connection identifier for the connection. If the request is going to be a reader (e.g., it desires to receive data accessed via the target EP), a session ID is included in Connection Request Reply 1012. In one embodiment, the target EP's identifier is an extended unique identifier (EUI) (shown as T_EUI in FIG. 10), as defined by the IEEE EUI-64 standard for global identifiers. An EUI is a 64-bit global identifier that is issued by the IEEE, and is used to uniquely identify a device. The target's EUI is used to notify the FM about the connection status (open/closed). In one embodiment, Connection Request Reply 1012 further includes a sequence number (SeqNum), to provide a number the requesting EP should start with when sending its first packet.

When the requesting EP receives Connection Request Reply 1012, it replies with a Connection Acknowledgement 1014 in a block 908. The Connection Acknowledgment includes the requesting EP's global identifier (R_EUI), which is used to notify the FM about the connection status (open/closed). If the requesting EP is going to be a reader, the Connection Acknowledgement includes the pipe index previously sent in Connection Request Reply 1012. If the requesting EP is going to be a writer, the session ID included in Connection Request Reply 1012 is returned in the Connection Acknowledgement. The Connection Acknowledgement may also include a sequence number (the same as SeqNum) that is incremented by 1, which is used to confirm the sequence number the requesting EP will start with when sending its first packet.

In response to a Connection Acknowledgement 1014, the target EP returns a Connection Confirmation 1016 to the requesting EP in a block 910. If the requesting EP is going to be a writer, the Connection Confirmation includes a pipe index, and a pipe offset (e.g., where the requester can start reading/writing to). A pipe access key may also be provided for security purposes. If the requesting EP is going to be a reader, the session ID included in Connection Request Reply 1012 is returned in Connection Confirmation 1016.

At this point, information is sent to the FM to inform the FM that a new peer-to-peer connection between the requesting EP and target EP to establish the connection. In the embodiment of FIGS. 9 and 10, the FM is informed of the connection by sending an Add Connection message 1018 from the target EP to the FM, as depicted in a block 912. Under an alternative scheme, the Add Connection message may be sent from the requesting EP to the FM. The Add Connection message includes the EUI for each of the requesting and target EPs, as well as the requesting EP's pipe index or session ID (as appropriate) and the target EP's pipe index or session ID (as appropriate).

The FM keeps a record of each peer-to-peer connection established in its fabric. When the FM receives an add connection notification, it creates a new entry in its connections table. This entry is removed when the FM receives a remove connection request or it determines that one or both peers are no longer members of the fabric. In one embodiment, the connections table is a dynamic data structure implemented as a linked list

During ongoing operations, the routing topology of a given system may change. For example, new cards or boards may be added to a system using a hot install, or existing cards or boards may be removed. In response, the FM may determine that a better path exists between the peer-to-peer connection participants. In response, the FM notifies both participants of the new path providing the peer's EUI and new turnpool and turnpointer to reach the peer, as depicted by a Path Update message 1020 and a block 914 in FIG. 9.

There are various circumstances under which connections will/should be closed. For example, after a data transaction is completed, the requesting EP may desire to close the connection. There are also situations where connections will remain open between active uses. Connections may also be closed in response to detected conditions. In one embodiment, the same format is used when either an endpoint wishes to stop a peer-to-peer session or when the FM determines that one of the peers is no longer capable of participating in the connection.

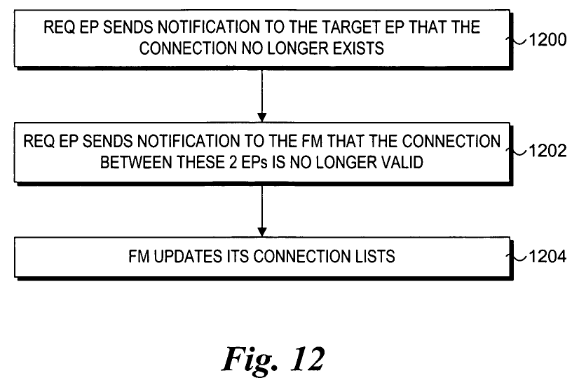

A flowchart illustrating operations performed during an endpoint-initiated connection closure process is shown in FIG. 12. The process starts in a block 1200, wherein the requesting EP sends a notification to the target EP that the connection no longer exists. The requesting EP also sends notification to the FM that the connection between the requesting EP and target EP is no longer valid. In one embodiment, the notification includes the pipe index/sessionID and the EUI for each peer. The FM then updates it connection list in a block 1204 to reflect the removed connection.

In general, the connection management techniques disclosed herein may be implemented in modular systems that employ serial-based interconnect fabrics, such as PCI Express components. For example, PCI Express components may be employed in blade server systems and modular communication systems, such as ATCA systems.

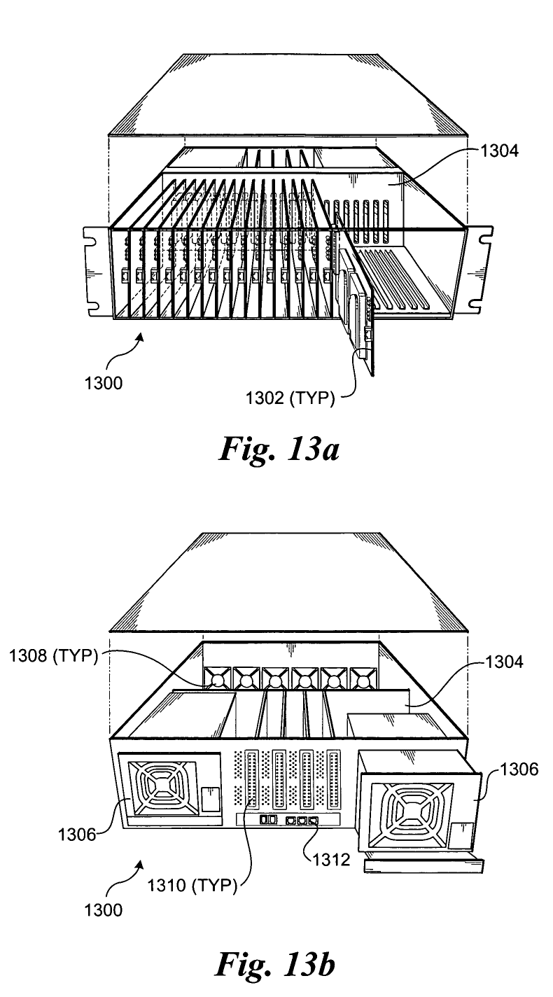

Typical blade server system and components are shown in FIGS. 13a and 13b. Under a typical configuration, a rack-mounted chassis 1300 is employed to provide power and communication functions for a plurality of server blades (i.e., blades) 1302, each of which occupies a corresponding slot. (It is noted that all slots in a chassis do not need to be occupied.) In turn, one or more chassis 1300 may be installed in a blade server rack (not shown). Each blade is coupled to an interface plane 1304 (i.e., a backplane or mid-plane) upon installation via one or more mating connectors. Typically, the interface plane will include a plurality of respective mating connectors that provide power and communication signals to the blades. Under current practices, many interface planes provide “hot-swapping” functionality—that is, blades can be added or removed (“hot-swapped”) on the fly, without taking the entire chassis down through appropriate power and data signal buffering.

A typical mid-plane interface plane configuration is shown in FIGS. 13a and 13b. The backside of interface plane 1304 is coupled to one or more power supplies 1306. Oftentimes, the power supplies are redundant and hot-swappable, being coupled to appropriate power planes and conditioning circuitry to enable continued operation in the event of a power supply failure. A plurality of cooling fans 1308 are employed to draw air through the chassis to cool the server blades.

The illustrated blade server further includes one or more switch fabric cards 1310, each of which is coupled to interface plane 1304, and a management switch card 112 that is coupled to the backside or frontside of the interface plane. Generally, a switch fabric card is used to perform switching operations for the serial-based interconnect fabric. The management switch card provides a management interface for managing operations of the individual blades. The management card may also function as a control card that hosts an FM.

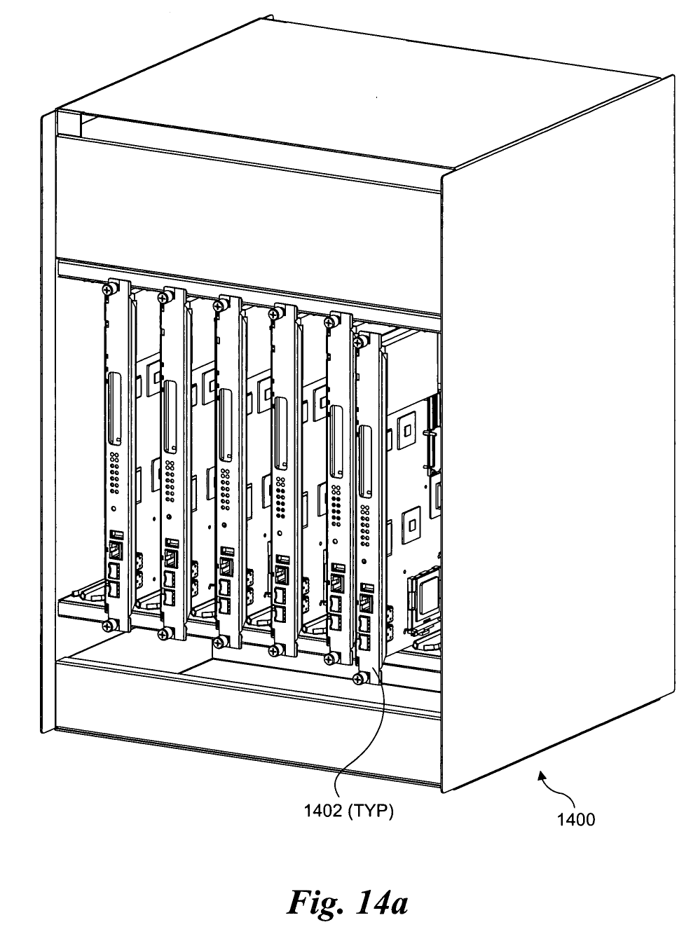

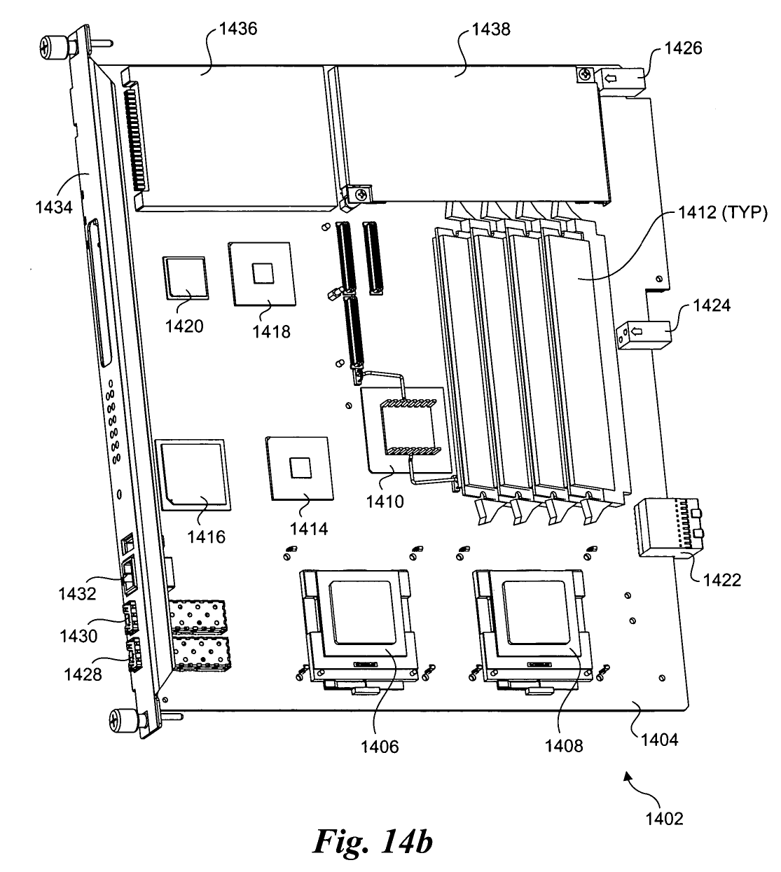

An exemplary ATCA chassis 1400 and ATCA board 1402 are shown in FIGS. 14a and 14b. The ATCA chassis is somewhat similar to a blade server chassis, and includes a connection plane (not shown) via which one or more ATCA boards 1402 may be coupled by inserting the board(s) into respective chassis slots. The connection plane (a.k.a., backplane) supports data routing between PCI Express devices. In one embodiment, two slots, are reserved for switching boards. In general, the ATCA specification supports various types of fabric topologies, such as star, dual-star, and meshes.

FIG. 14b shows an exemplary ATCA board 1402. The ATCA board includes a mainboard 1404 comprising a printed circuit board (PCB) to which various components are coupled. These include processors 1406 and 1408, a memory controller hub 1410, a plurality of memory devices 1412 (e.g., single inline memory modules (SIMMs)), and various other integrated circuits (ICs), depicted as ICs 1414, 1416, 1418, and 1420. In general, processors 1406 and 1408 are illustrative of various types of processing units, including but not limited to CPUs, NPUs, microcontrollers, and co-processors.

Various connectors are coupled to mainboard 1404 for power distribution and input/output (I/O) functions. These include a backplane data connector 1422, power input connectors 1424 and 1426, which are configured to coupled to the backplane, and universal serial bus (USB) connectors 1428 and 1430, and a network connector 1432, which are mounted to a front panel 1434.

Depending on the particular board configuration, an ATCA board may include additional components. Such additional components are exemplified by a disk drive 1436 and a daughterboard 1438. The ATCA board may also provide mezzanine expansion slots.

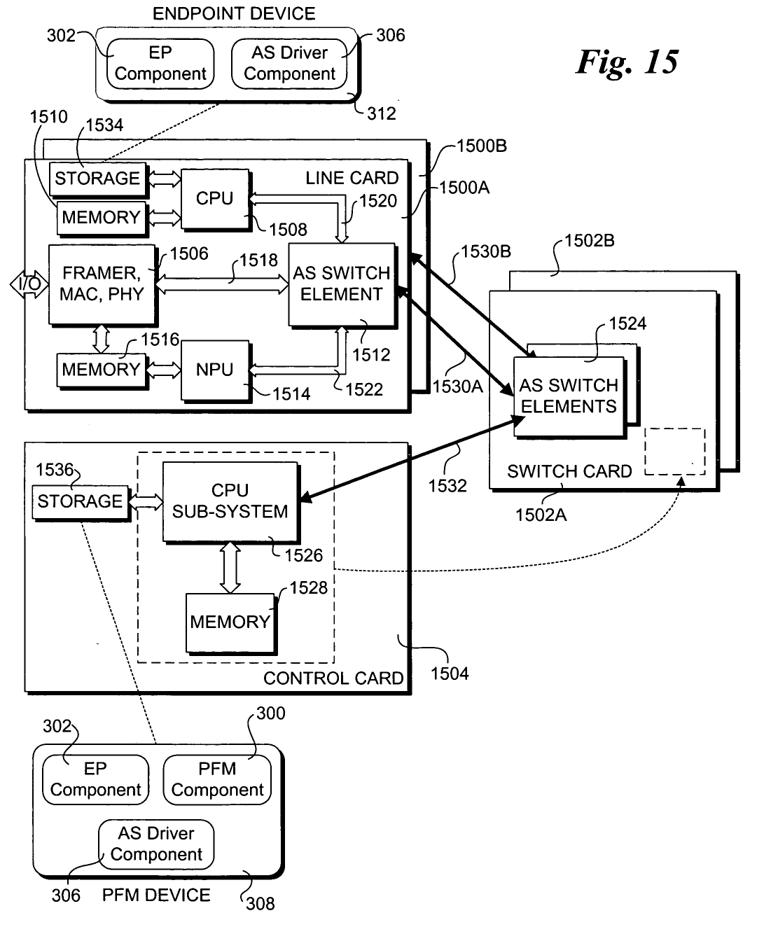

As discussed above, AS fabrics may be employed for both compute and communication ecosystems. An exemplary communications implementation is shown in FIG. 15. Exemplary boards employed in the implementation include a pair of line cards 1500A and 1500B, a pair of switch cards 1502A and 1502B, and a control card 1504. Switch cards 1502A and 1502B are represented of an AS fabric 1503. Each of line cards 1500A and 1500B include a framer, media access channel (MAC) component, and physical layer (PHY) component, collectively depicted as a component 1506 for convenience. The line cards further include a CPU 1508, coupled to memory 1510 and a local line card AS switch element 1512, and a NPU 1514, coupled to memory 1516 and AS switch element 1512. In one embodiment, component 1506, CPU 1508, and NPU 1514 are coupled to AS switch element 1512 via respective AS links 1518, 1520, and 1522.

Switch cards 1502A and 1502B are used to support the AS switch fabric functionality. This is facilitated by AS switch elements 1524. Control card 1504 is used to manage the AS switch fabric by controlling the switching operation of switch cards 1502A and 1502B, and includes a CPU sub-system 1526 and memory 1528. In one embodiment, the functionality depicted as being performed by control card 1504 is performed by one of switch cards 1502A or 1502B. In general, CPU sub-system 1526 and memory 1528 is illustrative of fabric manager host circuitry that is used to run the fabric manager software components.

Each of line cards 1500A and 1500B is connected to AS fabric 1503 via a respective AS link 1530A and 1530B. Similarly, control card 1504 is connected to AS fabric 1503 via an AS link 1532.

Each of line cards 1500A and 1500B functions as an endpoint device 312. Thus, the software components for an EP device, comprising an instance of EP component 302 and AS driver component 306, are loaded into memory 1510 and executed on CPU 1508 (in conjunction with an operating system running on CPU 1508). The EP device software components may be stored on a given line card using a persistent storage device, such as but not limited to a disk drive, a read-only memory, or a non-volatile memory (e.g., flash device), which are collectively depicted as storage 1534. Optionally, one or more of the software components may comprise a carrier wave that is loaded into memory 1510 via a network.

Either control card 1504 (if used to manage the AS fabric) or one of switch cards 1502A or 1504B (if including the equivalent functionality depicted for control card 1504) is used to function as a PFM device 308. Thus the PFM device software components including an instance of EP component 302, PFM component 300 and AS driver 306 are loaded into memory 1528. In a manner analogous to the line cards, in one embodiment, the PFM device software components are stored in a persistent storage device, depicted as storage 1536. In another embodiment, one or more of the PFM device software components are loaded into memory 1528 via a network.

Furthermore, the code (e.g., instructions) and data that are executed to perform the endpoint, PFM, and SFM operations comprise software elements executed upon some form of processing core (such as the CPU) or otherwise implemented or realized upon or within a machine-readable medium. A machine-readable medium includes any mechanism for storing or transmitting information in a form readable by a machine (e.g., a computer). For example, a machine-readable medium can include such as a read only memory (ROM); a random access memory (RAM); a magnetic disk storage media; an optical storage media; and a flash memory device, etc. In addition, a machine-readable medium can include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method to establish a peer-to-peer connection between endpoints coupled to a serial-based interconnect fabric, comprising:
sending a query from a requesting endpoint to a fabric manager requesting connection information for at least one target endpoint having attributes matching attributes specified in the query;
returning a query reply from the fabric manager to the requesting endpoint containing connection information to connect the requesting endpoint to a target endpoint having attributes matching attributes specified in the query; and
negotiating a peer-to-peer connection between the requesting endpoint and the target endpoint to establish the peer-to-peer connection.

2. The method of claim 1, further comprising:
sending a query from a requesting endpoint to a fabric manager requesting connection information for any target endpoints having attributes matching attributes specified in the query;
returning a query reply from the fabric manager to the requesting endpoint containing connection information to connect the requesting endpoint to at least two target endpoints having attributes matching attributes specified in the query; and
selecting a target endpoint from among the at least two target endpoints to negotiate the peer-to-peer connection with.

3. The method of claim 1, wherein the serial-based interconnection fabric comprises an Advanced Switching (AS) fabric, and each of the requesting and target endpoints comprises an AS-compliant device.

4. The method of claim 1, further comprising:
notifying the fabric manager that a new peer-to-peer connection has been established; and
updating a list of peer-to-peer connections maintained by the fabric manager to included the new peer-to-peer connection.

5. The method of claim 1, further comprising:
closing the peer-to-peer connection; and
sending a notification to the fabric manager that the connection has been closed; and
updating a list of peer-to-peer connections maintained by the fabric manager to remove the peer-to-peer connection that has been closed.

6. The method of claim 5, wherein closing the peer-to-peer connection comprises:
sending a notification from a endpoint peer initiating closing of the peer-to-peer connection to the other endpoint peer that the connection no longer exists.

7. The method of claim 1, wherein the serial-based interconnect fabric comprises a first set of PCI Express devices including at least one PCI Express device, and wherein at least one of the requesting and target endpoints comprise a PCI Express device that is not included in the first set of PCI Express devices.

8. The method of claim 1, wherein negotiating the peer-to-peer connection comprises:
sending a connection request from the requesting endpoint to the target endpoint; and
responding to the connection request by sending a connection accepted message from the target endpoint to the requesting endpoint.

9. The method of claim 8, wherein negotiating the peer-to-peer connection further comprises:
sending a connection established acknowledgement message from the requesting endpoint to the target endpoint; and
returning a connection confirmation message from the target endpoint to the requesting endpoint.

10. The method of claim 8, further comprising:
exchanging session identification (ID) information between the requesting endpoint and the target endpoint to agree on a session ID for the peer-to-peer connection.

11. The method of claim 8, further comprising:
exchanging pipe index information between the requesting endpoint and the target endpoint, the pipe index information specifying a connection identifier to be used for the peer-to-peer connection.

12. The method of claim 11, further comprising:
sending a pipekey from one of the requesting and target endpoints to the other endpoint, the pipekey to be employed for security purposes.

13. The method of claim 1, further comprising:
detecting a change in a topology of the serial-based interconnect fabric;
determining a route between the requesting endpoint and the target endpoint is to be rerouted; and
providing routing information to the requesting endpoint to reroute the route between the requesting endpoint and the target endpoint.

14. The method of claim 1, further comprising:
detecting that a device hosting one of the requesting and target endpoints can no longer communicate with the serial-based interconnect fabric; and, in response,
closing the peer-to-peer connection.

15. An article of manufacture, comprising:
a machine-readable medium to provide instructions, which if executed perform operations including,
generating a target match query defining a set of attributes provided by a target endpoint to which a requesting endpoint desires to connect via a serial-based interconnect fabric to which the requesting and target endpoints are coupled;
sending the target match query from the requesting endpoint to a fabric manager requesting connection information for at least one target endpoint providing attributes matching attributes specified in the query;
returning a query reply from the fabric manager to the requesting endpoint containing connection information to connect the requesting endpoint to a target endpoint having attributes matching attributes specified in the query; and
negotiating a peer-to-peer connection between the requesting endpoint and the target endpoint to establish the peer-to-peer connection.

16. The article of manufacture of claim 15, wherein the serial-based interconnection fabric comprises an Advanced Switching (AS) fabric, and each of the requesting and target endpoints comprises an AS-compliant device.

17. The article of manufacture of claim 15, wherein execution of the instructions performs further operations including:
notifying the fabric manager that a new peer-to-peer connection has been established; and
updating a list of peer-to-peer connections maintained by the fabric manager to included the new peer-to-peer connection.

18. The article of manufacture of claim 15, wherein negotiating the peer-to-peer connection comprises:
sending a connection request from the requesting endpoint to the target endpoint; and, in response,
returning a connection accepted message from the target endpoint to the requesting endpoint.

19. The article of manufacture of claim 18, wherein negotiating the peer-to-peer connection further comprises:
sending a connection established acknowledgement message from the requesting endpoint to the target endpoint; and
returning a connection confirmation message from the target endpoint to the requesting endpoint.

20. The article of manufacture of claim 15, wherein the instructions are embodied as a set of software components, including:
an endpoint component, to be executed on respective devices corresponding to each of the requesting and target endpoints; and
a fabric manager component, to be executed on a device selected to perform management of the serial-based interconnect fabric.

21. The article of manufacture of claim 20, wherein each of the endpoint component and fabric manager component includes a plurality of sub-components, a portion of the sub-components to be executed in a user space of an operating system running on each of the respective devices, a portion of the sub-components to be executed in a kernel space of the operating system.

22. The article of manufacture of claim 15, wherein execution of the instructions perform the further operations including:
detecting a change in a topology of the serial-based interconnect fabric;
determining a route between the requesting endpoint and the target endpoint is to be rerouted; and
providing routing information to the requesting endpoint to reroute the route between the requesting endpoint and the target endpoint.

23. A line card apparatus, comprising:
a network processing unit (NPU);
memory, coupled to the NPU;
an Advance Switching (AS) switch element, linked in communication with the NPU, the AS switch element coupled to a connector configured to connect the apparatus to an AS Fabric via an AS link;
a central processing unit (CPU);
memory, coupled to the CPU; and
a storage device, having instructions stored therein, which if executed by the CPU perform operations including,
sending a query to a fabric manager via an AS link requesting connection information for at least one target endpoint having attributes matching attributes specified in the query;
receiving a query reply from the fabric manager containing connection information to connect the requesting endpoint to a target endpoint having attributes matching attributes specified in the query; and
negotiating a peer-to-peer connection with the target endpoint to establish peer-to-peer connection with the target endpoint.

24. The line card apparatus of claim 23, wherein the line card comprises a server blade;

25. The line card apparatus of claim 23, wherein the line card comprises an Advanced Telecom Computer Architecture (ATCA) board.

26. A system, comprising:
a chassis, including a backplane;
a first endpoint device, coupled to the backplane;
a second endpoint device, coupled to the backplane;
at least one switching device, coupled to the backplane, said at least one switching device comprising a serial-based interconnect fabric; and
a fabric management device, operatively coupled to control switching operation of the serial-based interconnect fabric;
wherein each of the first and second endpoint devices and the fabric management host device have an endpoint software component stored thereon, and the fabric management device further stores a fabric management software component, and wherein execution of the endpoint software components by the first and second endpoint devices and the fabric management device and execution of the fabric manager software component by the fabric management device enables a peer to peer connection between the first and second endpoint devices to be established by performing operations including,
sending a query from the first endpoint device to the fabric management device requesting connection information for at least one target endpoint device having attributes matching attributes specified in the query;
returning a query reply from the fabric management device to the first endpoint device containing connection information to connect the first endpoint device to a target endpoint device having attributes matching attributes specified in the query, the target endpoint device comprising the second endpoint device; and
negotiating a peer-to-peer connection between the first endpoint device and the second endpoint device to establish the peer-to-peer connection.

27. The system of claim 26, wherein the chassis comprises an Advanced Telecom Computer Architecture (ATCA) chassis, and each of the first and second endpoint devices and said at least one switching device comprises ATCA boards.

28. The system of claim 26, wherein the chassis comprises a blade server chassis, and each of the first and second endpoint devices and said at least one switching device comprise server blades.

29. The system of claim 26, wherein the fabric management device comprises a control card coupled to the serial-based interconnect fabric.

30. The system of claim 26, wherein the fabric management device comprises one of said at least one switching device.
